(19) United States
(12) Patent Application Publication
(10) Pub. No.: US 2008/0054755 A1
(43) Pub. Date: Mar. 6, 2008

(54) Thermoelectric generator

(75) Inventor: Tatsuo Obata, Sapporo (JP)

Correspondence Address: HARNESS, DICKEY & PIERCE, P.L.C., P.O. BOX 828, BLOOMFIELD HILLS, MI, 48303, US

(73) Assignee: KOHOKUTHERMO Co., Ltd.

(21) Appl. No.: 11/895,486

(22) Filed: Aug. 24, 2007

(30) Foreign Application Priority Data
Aug. 30, 2006 (JP) 2006-234091

(51) Int. Cl. H02N 11/00; F23D 3/00

(52) U.S. Cl. 310/306; 431/326

(57) ABSTRACT

To produce a stable electromotive force in a thermoelectric generator having a thermoelectric element that has a cooling part and a heating part and generates electric power by utilizing a temperature difference between the cooling part and the heating part.

A thermoelectric generator includes a thermoelectric element that has a cooling part and a heating part and that generates electric power by utilizing a temperature difference between the cooling part and the heating part, and a heat source for heating the heating part is a micro flame. The thermoelectric generator includes: a container for containing liquid fuel; a burner tube that is connected with the interior of the container and projects from the container; and a string of a capillary tube that passes through the burner tube from the container and projects outside from the burner tube. The micro flame is produced at the top end of the burner tube by the liquid fuel transported to the top end of the string by means of a capillary phenomenon.

### CLAIM OF PRIORITY

This application claims the benefit of Japanese Patent Applications No. 2006-234091 filed on Aug. 30, 2006, the entire contents of which are hereby incorporated by reference herein.

### BACKGROUND OF THE INVENTION

1. Field of the Invention

The present invention relates to a thermoelectric generator.

2. Description of the Related Art

A thermoelectric element utilizing a Seebeck effect has been provided as a thermoelectric element that has a cooling part and a heating part and that generates electric power by utilizing a temperature difference between the cooling part and the heating part. The Seebeck effect is a phenomenon such that when a p-type semiconductor and an n-type semiconductor are joined to each other and have a temperature difference caused between them, an electromotive force corresponding to the temperature difference can be produced. In recent years, technologies relating to a thermoelectric generator utilizing this Seebeck effect have been proposed (refer to, for example, “Thermoelectric Generation by Temperature Difference utilizing Hot Spring”; by Atsuhiro URAIE, Tadashi SAKAGUCHI, Yasuhiro YOKOYAMA, and Isamu TODO; Solar Energy, Japan Solar Energy Society, 1999, Vol. 25, No. 6, p. 49).

On the other hand, a micro flame is a singular flame that can keep a nearly spherical shape even under a terrestrial field and that is similar to a combustion phenomenon under a non-gravitational field. The flame has a diameter of a few millimeters. For example, in the case of using methane gas as fuel, when the methane gas of the order of a few cubic centimeters per minute in terms of a standard state is supplied from a small pipe having a diameter of about 1 mm, a semispherical micro flame having a slightly larger diameter than the outside diameter of the pipe can be produced. The micro flame has received attention as a highly effective and highly controllable heat source (refer to, for example, “Thermal and Fluid Dynamic Structures of Micro-Diffusion Flames”; by Yuji NAKAMURA and Kozo SAITO; Nagare, Japan Society of Fluid Mechanics, 2001, Vol. 20, No. 2, pp. 74-82).

The waste heat of a factory or the like is used as a main heat source for generating electric power by the use of a thermoelectric element. However, such a heat source not only is unstable in temperature but also is brought into an excessively high temperature, which brings about a case where the heat source excessively heats also the cooling part of the thermoelectric element that is supposed to be cooled under a normal condition. Thus, this heat source makes it difficult for the thermoelectric element to produce a stable electromotive force.

### SUMMARY OF THE INVENTION

Hence, the object of the present invention is to produce a stable electromotive force in a thermoelectric generator using a thermoelectric element that has a cooling part and a heating part and that generates a stable electric power by utilizing a temperature difference between the cooling part and the heating part.

To solve the above-mentioned problem, a thermoelectric generator according to the present invention has a thermoelectric element that has a cooling part and a heating part and that generates electric power by utilizing a temperature difference between the cooling part and the heating part, wherein a heat source for heating the heating part is a micro flame.

According to this invention, the micro flame keeps a constant shape of a nearly hemispherical shape and hence can stably heat the heating part of the thermoelectric element. The temperature of the micro flame is usually lower than that of the other combustion flame. Moreover, the heating region of the micro flame is usually smaller than that of the other combustion flame. Thus, the micro flame can prevent the cooling part of the thermoelectric element, which is not to be heated under normal conditions, from being heated. As a result, the thermoelectric generator can be stable in a temperature difference between the cooling part and the heating part of the thermoelectric element and hence can generate a stable electromotive force. In this regard, the micro flame refers to a flame which is formed generally in the shape of a sphere, a semi-sphere, a cone, an elliptic body, or a semi-elliptic body and one maximum diameter of which is 4 mm or less, and is distinct from a combustion flame of meso scale (maximum diameter is larger than 4 mm).

In a thermoelectric generator according to another invention, in addition to the above-mentioned invention, the heat source includes a plurality of micro flames. By employing the heat source like this, the larger area of the heating part of the thermoelectric element can be heated. Moreover, when a micro flame formed by a combination of the plurality of micro flames is used as a heat source, the micro flame can generate high thermal energy that cannot be generated by one micro flame.

In a thermoelectric generator according to another invention, in addition to the above-mentioned invention, the micro flame can be produced by burning liquid fuel that is liquid at room temperature and normal pressure. By employing the micro flame like this, complex and heavy members such as a high-pressure cylinder and a high-pressure valve that are used in a case where gas is used as fuel are not required, so this thermoelectric generator has an advantage in terms of fuel and the ease of handling the thermoelectric generator.

In a thermoelectric generator according to another invention, the liquid fuel in the above-mentioned invention is ethanol or a mixture of ethanol and a solvent. By employing the liquid fuel like this, it is possible to provide a thermoelectric generator having excellent environmental harmony.

A thermoelectric generator according to another invention, in addition to the above-mentioned invention, includes: a container for containing the liquid fuel; a cylindrical body that is connected with the interior of the container and projects from the container; and a capillary tube that passes through the cylindrical body from the container and projects outside from the container, wherein the micro flame is produced at the top end of the cylindrical body by the liquid fuel transported to the top end of the capillary tube by means of a capillary phenomenon. By employing this construction, the capillary phenomenon can be used for the transportation of the fuel and hence the structure of the thermoelectric generator can be simplified.

In a thermoelectric generator according to another invention, in addition to the above-mentioned invention, all or part of the heating part is opposed to the side portion of the micro flame. By employing this construction, the effect of fluctuations in the thermal energy caused near the top of the combustion flame can be reduced and the rate of contribution of radiant heat can be increased, which can further stabilize the output of the thermoelectric element.

According to the present invention, a stable electromotive force can be produced in a thermoelectric generator that has a cooling part and a heating part and that generates electric power by utilizing a temperature difference between the cooling part and the heating part.

### BRIEF DESCRIPTION OF THE DRAWINGS

FIG. 1 is a diagram showing the outline of a main construction of a thermoelectric generator according to an embodiment of the present invention;

FIG. 2 is a diagram showing the outline of a longitudinal sectional view of a heat source unit shown in FIG. 1;

FIGS. 3A to 3C are diagrams showing states when a micro flame is viewed from the side;

FIGS. 4A to 4C are diagrams showing the outline of the thermoelectric generator utilizing the micro flame shown in FIGS. 3A to 3C;

FIG. 5 is a diagram showing a longitudinal sectional view of the outline of a modification of a thermoelectric generator according to the embodiment of the present invention;

FIG. 6 is a table showing the electromotive forces of the thermoelectric generators measured in respective experiments; and

FIGS. 7A to 7C are diagrams showing temporal changes in the electromotive forces of the thermoelectric generators measured in the respective experiments.

### DESCRIPTION OF THE PREFERRED EMBODIMENTS

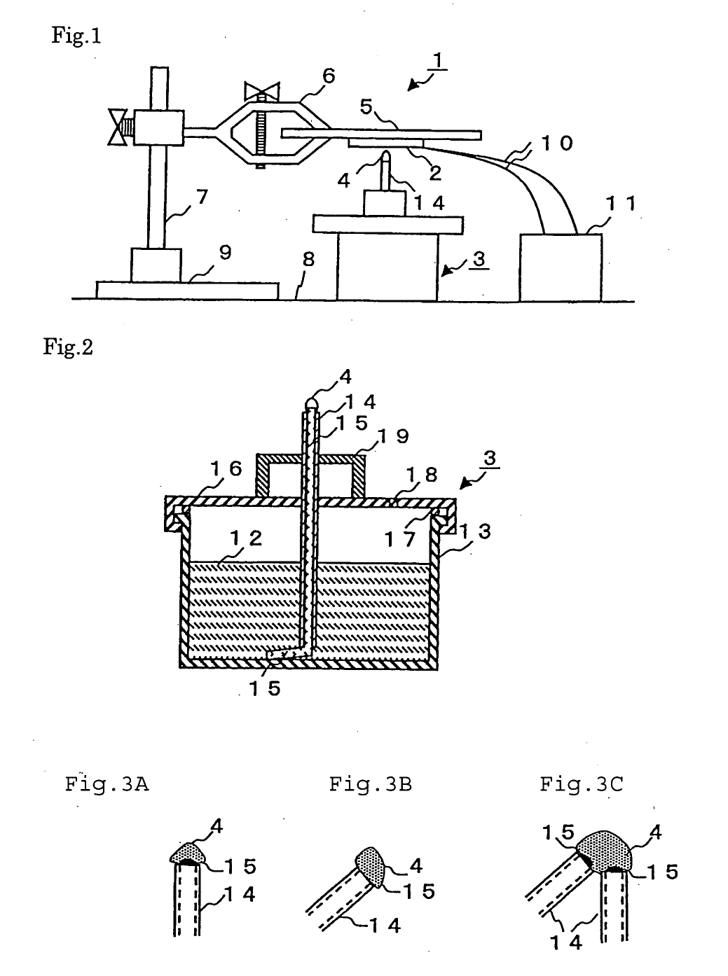

Hereinafter, a thermoelectric generator according to an embodiment of the present invention will be described with reference to the drawings. FIG. 1 is a diagram showing the outline of the main construction of a thermoelectric generator 1 according to an embodiment of the present invention. The thermoelectric generator 1 has a thermoelectric element (Peltier element) 2 that has a cooling part and a heating part and that generates electric power by utilizing a temperature difference between the cooling part and the heating part. A heat source unit 3 for heating the heating part produces a micro flame 4.

The thermoelectric element 2 is fixed to a portion located nearly in the center of one surface (lower surface) of an aluminum substrate 5 having a larger area than the thermoelectric element 2. The thermoelectric element 2 is preferably fixed to the aluminum substrate 5 by an aluminum adhesive tape. The thermoelectric element 2 is an element that can generate an electromotive force when a cooling part on its upper surface is cooled and a heating part on its lower surface is heated. The aluminum substrate 5 acts as a heat radiating plate for cooling the cooling part of the thermoelectric element 2. The aluminum adhesive tape having an excellent heat conductance is used so as not to block the heat radiation of the aluminum substrate 5. Moreover, the heating part of the thermoelectric element 2 is heated by the micro flame 4. The above-mentioned aluminum adhesive tape having an excellent heat conductance is used so as not to block the heating of the heating part by the micro flame 4.

The thermoelectric element 2 is fixed to a portion located nearly in the center of the aluminum substrate 5. The surface of the aluminum substrate 5 to which the thermoelectric element 2 is fixed is gripped and fixed by a clamp 6 fastened by a screw. The clamp 6 is fixed by a support column 7 and the support column 7 is fixed by a support base 9 placed on an installation plane 8. Electricity generated by the thermoelectric element 2 is supplied to a load 11 of an electronic device or the like through electric wires 10 connected to the thermoelectric element 2.

FIG. 2 is a diagram showing the outline of the structure of the heat source unit 3 shown in FIG. 1. The heat source unit 3 produces the micro flame 4 by burning liquid fuel 12, which is liquid at room temperature and normal pressure. Moreover, it is preferable that the liquid fuel 12 is ethanol or a mixture of ethanol and a solvent. In this embodiment, ethanol is used as the liquid fuel 12. The heat source unit 3 has a container 13 for containing the liquid fuel 12, a copper burner tube 14 of a cylindrical body that is connected with the interior of the container 13 and is projected from the container 13, and a cotton string 15 that passes through the burner tube 14 from the container 13 and that has a function as a capillary tube slightly projecting outside from the top end of the burner tube 14. The liquid fuel 12 is transported to the top end of the string 15 by a capillary phenomenon to thereby produce the micro flame 4 at the top end of the burner tube 14.

Moreover, the heat source unit 3 has a cover 16 for tightly sealing the opening of the container 13 to prevent the liquid fuel 12 from being evaporated and sprayed. The cover 16 is removably fixed to the container 13 by packing member 17 made of rubber or the like. The cover 16 is surely sealed to the burner tube 14 by bonding, brazing, or the like. The cover 16 has an air vent 18 formed therein to prevent pressure in the container 13 from being increased. It is preferable that the size of the air vent 18 is smaller than the outside diameter of the burner tube 14 so as to decrease the amount of the evaporated liquid fuel 12 that is sprayed to the outside of the cover 16. Moreover, the cover 16 has a support member 19 for assisting the support of the burner tube 14.

When the top end of the burner tube 14 is ignited by a lighter for tobacco or the like, the liquid fuel 12 soaked into the string 15 is evaporated to be put into contact with oxygen in a small space near the top end of the burner tube 14, whereby the combustion reaction of the liquid fuel 12 is started. This combustion reaction is developed in the small space of the string 15 slightly projected outside from the top end of the burner tube 14. When a relationship between the consumption speed of oxygen consumed in the small space and the speed of oxygen that is diffused from the surrounding atmosphere and that is supplied to the small space becomes a constant relationship, the combustion flame in the small space becomes the micro flame 4. To realize the constant relationship, the length of a portion of the string 15 that is projected outside from the top end of the burner tube 14 is adjusted. One of methods to adjust the length of a portion of the string 15 is to elongate the portion of the string 15 that is projected outside from the top end of the burner tube 14 and to ignite the portion. This method is effective, for example, in a case where the amount of the liquid fuel 12 soaked into the portion of the string 15 projected outside from the top end of the burner tube 14 is small. That is, when the portion of the string 15 is ignited, the amount of the liquid fuel 12 is small and the amount of oxygen in the surrounding is large at the beginning, so the string 15 is burned. However, as the portion of the string 15 projected outside from the top end of the burner tube 14 is burned out and shortened, the above-mentioned relationship between the consumption and supply of the oxygen becomes close to the constant relationship. Then, finally, only the liquid fuel 12 is burned without the string 15 being burned and continues being burned for a long time in the state where the combustion flame is the micro flame 4.

FIGS. 3A to 3C show states when the micro flame 4 produced in this manner is viewed from the side. The micro flame 4 shown in FIG. 3A is found to have a nearly semispherical shape or a nearly conical shape having a diameter slightly larger than the inside diameter of the burner tube 14. The micro flame 4 shown in FIG. 3B shows the state of the micro flame 4 when the burner tube 14 is inclined (so that an angle formed by the burner tube 14 and the horizontal plane becomes about 10 degrees). The present inventor found that the micro flame 4 when the liquid fuel 12 was burned was in a combustion state under almost non-gravitational environment and kept the same combustion state irrespective of the direction of the opening of the burner tube 14, just as with the micro flame when gaseous fuel 12 is burned. Even if the burner tube 14 is inclined, the micro flame 4 is hardly changed in the shape and characteristics of the micro flame 4 as compared with the case where the burner tube 14 is not inclined. Thus, even if it is required to incline the burner tube 14 from the viewpoint of the structure of the thermoelectric generator 1, the inclination of the burner tube 14 hardly presents a problem. The micro flame 4 shown in FIG. 3C shows a state in which a plurality of micro flames 4 are combined with each other to form one micro flame 4. This micro flame 4 produces the amount of heat nearly equal to the sum of the amounts of heat of the plurality of micro flames 4. In these micro flames 4, the liquid fuel 12 is nearly completely burned.

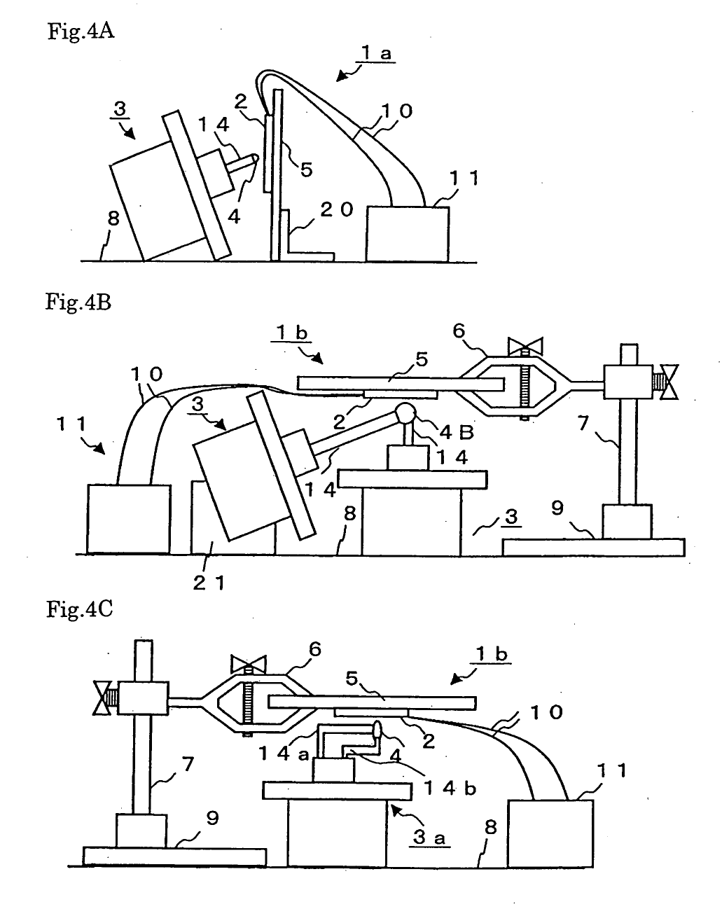

FIG. 4A is a diagram showing the outline of a thermoelectric generator 1a utilizing the micro flame 4 shown in FIG. 3B. The construction of the heat source unit 3 is the same as the construction of the heat source unit 3 shown in FIG. 1 and FIG. 2. However, the construction of the heat source unit 3 is different from the construction of the heat source unit 3 shown in FIG. 1 and FIG. 2 in that the heat source unit 3 is inclined for use. The aluminum substrate 5 is fixed by a fixing member 20 to place the thermoelectric element 2 in such a way that a surface to become the heating part of the thermoelectric element 2 is along a vertical direction. The heating part of the thermoelectric element 2 is mainly opposed to the side portion of the micro flame 4A and is heated by the side portion. When a usual combustion flame of meso scale is used, the top of the combustion flame is brought into high temperature. For this reason, air of low temperature surrounding the micro flame is entangled by convection to cause slight fluctuations in thermal energy, which easily causes variations in the output of the thermoelectric element 2. This can be said also for a micro flame formed by gaseous fuel and for a micro flame 4 formed by the liquid fuel 12 like this embodiment. When the thermoelectric element 2 is heated by the side portion of the micro flame 4, the fluctuations in the thermal energy can be avoided and the rate of contribution of radiant heat can be increased. As a result, the output of the thermoelectric element 2 can be further stabilized. Moreover, when the temperature of the heating part of the thermoelectric element 2 is 90° C. or less, water vapor produced by the burning of ethanol is brought into water droplets, which easily adhere to the heating part. However, by directing the surface to become the heating part of the thermoelectric element 2 nearly in a vertical direction, the water droplets are dropped down. For this reason, it is possible to prevent the micro flame 4A from being extinguished. Moreover, it is possible to decrease the loss of thermal energy when the water droplets are evaporated and to decrease a change in the electromotive force caused by the loss.

FIG. 4B is a diagram showing the outline of a thermoelectric generator 1b utilizing the micro flame 4 shown in FIG. 3C. As for the construction of the heat source unit 3, two heat source units identical to the heat source unit 3 shown in FIG. 1 and FIG. 2 are used. One of the two heat sources 3 is in contact with the bottom surface and the side surface of the container 13 and an inclining and fixing jig 21 for keeping a state where the heat source unit 3 is inclined is placed on an installation plane 8. Another heat source unit 3, as shown in FIG. 1, is placed on the installation plane 8 without being inclined. The micro flames 4 produced at the top ends of the respective burner tubes 14 of these heat source units 3 are combined with each other to produce the micro flame 4. The heating part of the thermoelectric element 2 is heated mainly by the vicinity of the top of the micro flame 4.

FIG. 4C is a diagram showing the outline of another thermoelectric generator 1b utilizing the micro flame 4 shown in FIG. 3C. Two burner tubes 14a, 14b through which the strings 15 are passed respectively are connected to each other and their top ends (sides opposed to the thermoelectric element 2) are arranged close to each other. The micro flames 4 produced at the top ends of these burner tubes 14a, 14b are combined with each other to produce one micro flame 4. The heating part of the thermoelectric element 2 is heated mainly by the vicinity of the top of the micro flame 4.

While the thermoelectric generators 1, 1a, and 1b according to this embodiment have been described above, the present invention can be implemented in various modifications unless the modifications depart from the spirit of the invention. For example, the fuel of the micro flame 4 may be gaseous fuel containing methane, butane, or the like. However, the gaseous fuel is usually stored in a high-pressure container and is supplied by a high-pressure valve, so there is a possibility that the thermoelectric generators 1, 1a, and 1b will be increased in weight. In this respect, the fuel that is liquid at room temperature and normal pressure does not need the high-pressure container and the high-pressure valve and hence has advantages of reducing the weights of the thermoelectric generators 1, 1a, and 1b and further reducing the risk of an accident of fuel leakage.

Moreover, the liquid fuel 12 may be other than ethanol. For example, kerosene, vegetable oil, and alcohol can be preferably used as the liquid fuel 12. However, ethanol is soluble in water and hence has the advantages of not only being mixed with water to adjust the amount of heat of the micro flame 4 but also being extinguished by the use of water. The mixing ratio of water of the liquid fuel 12 made by adding water to ethanol is preferably 50% or less in consideration of the ease with which the liquid fuel 12 is ignited, more preferably, 20% or less. Further, the liquid fuel 12 may be a mixture of ethanol and solvent other than water (for example, other alcohol).

Moreover, when the liquid fuel 12 contains ethanol, the ethanol may be ethanol produced in a petrochemical factory but the ethanol is preferably so-called bio-ethanol produced by fermenting vegetables. This is because ethanol has the advantage of possessing low toxicity to a human body and because bio-ethanol is excellent in environmental harmony. In this regard, when the bio-ethanol is used as fuel, the use of the bio-ethanol is not subjected to the discharge regulation of carbon dioxide that becomes the major cause of global warming, which is prescribed in the Kyoto Protocol.

In this embodiment, a string 15 made of cotton is used as the capillary tube. However, a string made of other natural fiber, chemical fiber such as nylon, glass fiber, and complex fiber of these fibers can be used as the string 15. In other words, any material can be used as the string 15, if the surface of the material can be wetted by the liquid fuel 12 and the material can transport the liquid fuel 12 by the use of surface tension caused thereon. Hence, even if the material is not formed in the shape of the string 15, the material can be used in place of the string 15 as long as the material has the function as a capillary tube.

In this embodiment, copper is selected as the material of the burner tube 14. This is because copper has high thermal conductivity and hence has the advantage of easily transmitting heat for evaporating liquid fuel in the burner tube 14 when the liquid fuel is ignited and burned. However, of course, other metal, glass, or ceramics can be selected as the material of the burner tube 14.

In this embodiment, means for utilizing the heat radiation effect of the aluminum substrate 5 and means for utilizing air conditioning (cooled air) have been described as cooling means of the cooling part of the thermoelectric element 2. However, needless to say, the cooling means is not limited to these means. For example, water or ice can be used as the cooling means. In a cold district, low-temperature air, low-temperature water and ice (snow) can be easily procured, so that the thermoelectric generators 1, 1a, and 1b are suitably used especially in the cold district.

In the thermoelectric generators 1, 1a, and 1b according to this embodiment, the heating part of one thermoelectric element 2 is heated by one or a plurality of micro flame(s) 4. These thermoelectric generators 1, 1a, and 1b are more efficient than the combustion flame of meso scale from the viewpoint of use efficiency of the radiant energy of the micro flame 4. This is because while the combustion flame of meso scale is large in size and hence heats also parts other than the heating part of the thermoelectric element 2 by radiant heat, the micro flame 4 is small in size and hence can apply nearly all of its radiant energy to the heating part of the thermoelectric element 2.

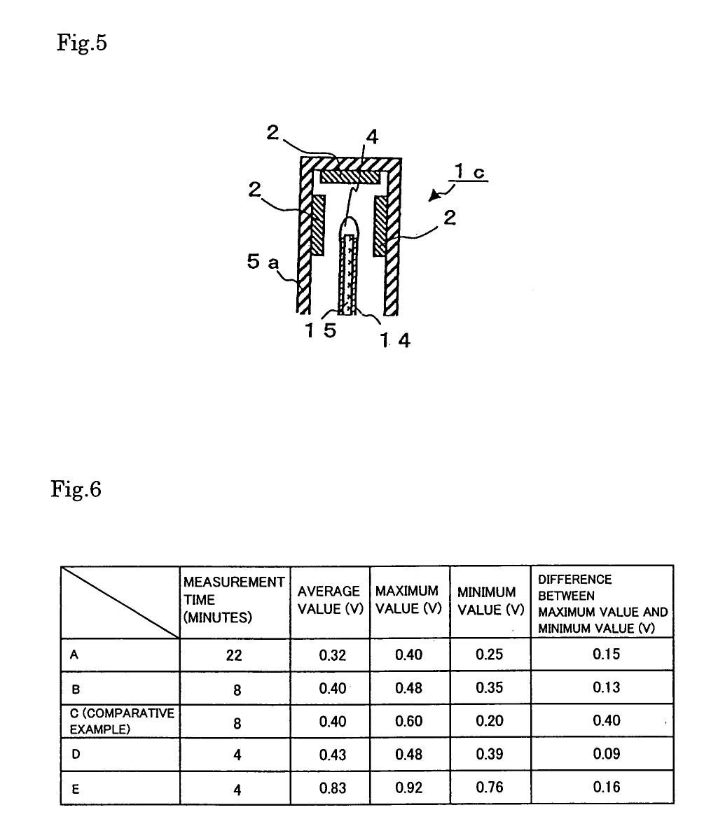

The use efficiency of the radiant energy of the micro flame 4 of the heat source unit 3 can be further increased. A thermoelectric generator 1c is a modification of the thermoelectric generator according to this embodiment, and FIG. 5 shows the longitudinal cross-sectional view of the outline of the thermoelectric generator 1c. In the thermoelectric generator 1c, the heating parts of a plurality of thermoelectric elements 2 are heated by one micro flame 4. For example, five thermoelectric elements 2 can be disposed in total on the four sides of and one upside of micro flame 4 just as with the thermoelectric generators 1, 1a. Thus, the thermoelectric generator 1c can increase the use efficiency of radiant energy several times as compared with the thermoelectric generators 1, 1a. In this regard, the thermoelectric element 2 and the cylindrical aluminum substrate 5a one end of which is closed, which are shown in FIG. 5, assume the role of reducing the effect of convection of air from the outside on the micro flame 4. It is preferable that this cylindrical aluminum substrate 5a has an air vent for easily supplying oxygen to the micro flame 4 from the outside. The thermoelectric generator 1c is a kind of thermoelectric generator in which all or part of the heating part of the thermoelectric element 2 is opposed to the side portion of the micro flame 4.

In this embodiment, it is preferable that the inside diameter of the burner tube 14 is 3 mm. In consideration of forming the micro flame 4 easily, the micro flame 4 preferably has its inside diameter formed in 3 mm or less, and more preferably, in a range from 0.5 mm to 2 mm. The reason why the micro flame 4 has its inside diameter formed in 0.5 mm or more is to manufacture the burner tube 14 more easily.

### EXAMPLE

Hereinafter, the examples of the thermoelectric generator according to the present invention will be described.

### Experimental Example 1

An experiment of measuring an electromotive force was performed by the use of the thermoelectric generator 1 having its main construction shown in FIG. 1 and FIG. 2. A tube of about 3 mm in outside diameter, about 2 mm in inside diameter, and about 90 mm in length was used as the burner tube 14. A cotton string of about 1 mm in diameter was used as the string 15. The string 15 was cut in a conical shape so as to project about 0.5 mm from the top end of the burner tube 14. Moreover, the string 15 is projected outside about 70 mm from the bottom end of the burner tube 14. A glass bottle of about 54 mm in outside diameter, about 50 mm in inside diameter, and about 50 mm in height was used as the container 13. A cover made of brass was used as the cover 16. A polyethylene sheet was stuck on the reverse side of the cover 16 and assumes the role of increasing hermeticity between the cover 16 and the container 13 just as with the packing member 17. A gas cylinder cap made of brass was used as the support member 19. In the cover 16 and the support member 19 was formed a hole of 3 mm in diameter through which the burner tube 14 was passed. The burner tube 14 was fixed to the support member 19 with non-dried clay and an adhesive tape made of aluminum. About 40 cc of ethanol as the liquid fuel 12 was put into the container 13. The string 15 projected from the bottom end of the burner tube 14 was put into contact with the ethanol. The ethanol was transported to the string 15 projected from the top end of the burner tube 14 by means of a capillary phenomenon. The ethanol transported to the top end of the burner tube 14 was ignited with an ignition lighter for a gas stove to produce the micro flame 4 formed in the shape shown in FIG. 3A. A commercially available Peltier element (FPH1-12707M (40 mm×40 mm×4 mm, made by Fujitaka Co., Ltd) was used as the thermoelectric element 2. A substrate having a size of 100 mm×180 mm×3 mm was used as the aluminum substrate 5.

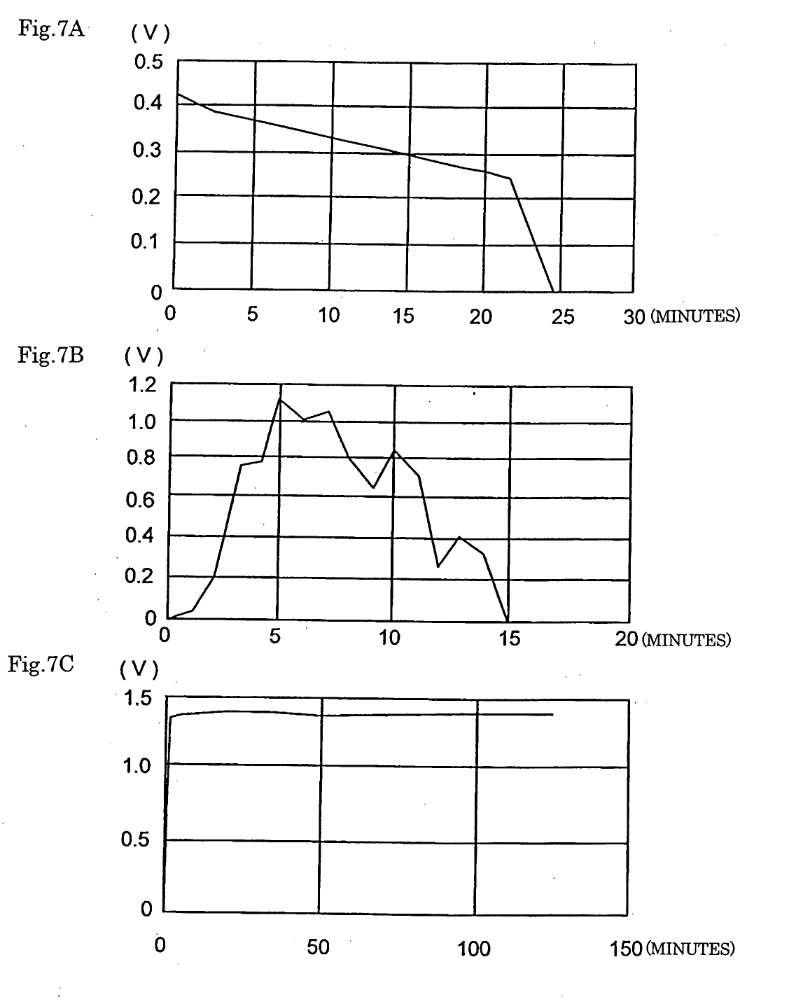

The micro flame 4 was formed in such a way that the top of the micro flame 4 was located 6 mm away below the bottom surface (heating part) of the thermoelectric element 2 fixed horizontally. The average value, maximum value, and minimum value of the electromotive force of the thermoelectric generator 1 were measured by a commercially available voltmeter. The measurement result is shown as “A” in the table shown in FIG. 6. A temporal change in the electromotive force is shown in FIG. 7A. As shown in “A”, the difference between the maximum value and the minimum value of the electromotive force was “0.15 V”. Thus, it was found that a stable electromotive force could be produced.

### Experimental Example 2

An experiment of measuring an electromotive force was performed, just as with the experimental example 1, by the use of the thermoelectric generator 1 having its main construction shown in FIG. 1 and FIG. 2. In this experimental example, however, the experiment was performed in a field where indoor air was flowed by air conditioning and the thermoelectric element 2 and the micro flame 4 were surrounded by a metal net to prevent air blowing. Moreover, the thermoelectric element 2 used in this experimental example was a commercially available Peltier element AISI TN08G132 (17 mm×17 mm×4 mm). The micro flame 4 was formed in such a way that the top of the micro flame 4 was located 6 mm away below the bottom surface (heating part) of the thermoelectric element 2 fixed horizontally. The average value, maximum value, and minimum value of the electromotive force of the thermoelectric generator 1 were measured by the commercially available voltmeter. The measurement result is shown as “B” in the table shown in FIG. 6.

Moreover, in this experimental example, the string 15 was pulled out by 1.5 mm from the top end of the burner tube 14 and was ignited. The electromotive force was measured in the same way by the use of the combustion flame of meso scale, having 6 mm in height and about 5 mm in maximum diameter, which is similar to a candle flame. The measurement result is shown as “C” in the table shown in FIG. 6. The combustion flame in “C” was not the micro flame 4. This combustion flame was formed in such a way that the top of the combustion flame was located 15 mm away below the bottom surface (heating part) of the thermoelectric element 2.

When “B” and “C” in the table shown in FIG. 6 are compared with each other, the difference between the maximum value and the minimum value of “B” was “0.13 V”, whereas the difference between the maximum value and the minimum value of “C” was “0.40 V”. Form this result, it was verified that the thermoelectric generator 1 according to this embodiment could produce a stable electromotive force as compared with the thermoelectric generator using the combustion flame of meso scale that is not the micro flame.

### Experimental Example 3

An experiment of measuring an electromotive force was performed as a second comparative example, just as with the experimental example 2, by the use of an thermoelectric generator using the combustion flame of a commercially available candle in place of the heat source unit 3. Here, AISIN TN08G132 was used as the thermoelectric element 2. A temporal change in the electromotive force is shown in FIG. 7B. Also when this measurement was performed, the thermoelectric element 2 was surrounded by a metal net so as to prevent air from being blown by air conditioning. A candle (6 mm in diameter and 50 mm in length) for Buddhist family altar made by KAMEYAMA Co., LTD was used. This candle was fixed to the installation plane 8 that was 70 mm away below the heating part of the thermoelectric element 2. When the candle was ignited, a combustion flame was intensely produced in a space of 20 mm between a portion at the height of 50 mm of the candle and the heating part of the thermoelectric element 2. The measurement of the electromotive force was started from the time when the candle was ignited. After 5 minutes from the ignition, the combustion flame intensely rose and hence the position of the heating part of the thermoelectric element 2 was moved up by 10 mm and was fixed there. The combustion flame after being moved was about 8 mm in diameter and about 30 mm in length. As the burning of the candle advanced, the candle was consumed and the position of the combustion flame was moved down, but the position of the combustion flame was not adjusted. After 15 minutes after the ignition, the candle was used up and the burning was finished. From the result of FIG. 7B, it is found that the electromotive force of the thermoelectric generator according to the second comparative example was very unstable.

### Experimental Example 4

The result obtained by measuring the electromotive force, just as with the experimental example 1, by the use of the thermoelectric generator 1a having the outline of its main construction shown in FIG. 4A is shown as “D” in the table shown in FIG. 6. As shown in “D”, the difference between the maximum value and the minimum value of the electromotive force was “0.09 V”. Thus, it was found that the thermoelectric generator could produce more stable electromotive force. Here, in this experimental example, the heating part of the thermoelectric element 2 was located about 6 mm away from the side portion of the micro flame 4. Moreover, the main constituent members of the thermoelectric generator 1a were the same as those of the thermoelectric generator 1 of the experimental example 1.

Moreover, in this experimental example, the thermoelectric generator 1a was modified to have the same construction as the thermoelectric generator 1 and the position of the thermoelectric element 2 was changed so that the heating part of the thermoelectric element 2 is heated mainly by the top of the micro flame 4. In this state, the measurement of the electromotive force was performed just as with the experiment 1. The measurement result is shown as “E” in the table shown in FIG. 6. As shown in “E”, the difference between the maximum value and the minimum value of the electromotive force was “0.16 V”. Thus, it was found that this experimental example could produce a stable electromotive force. Moreover, when “D” and “E” are compared with each other, the standard deviation of the value of the electromotive force was 0.14 for “D” and 0.35 for “E”. From this, it is found that the measurement result “D” obtained when the heating part of the thermoelectric element 2 was heated by the side portion of the micro flame 4 is more stable in the electromotive force than the measurement result “E” obtained when the heating part of the thermoelectric element 2 was heated by the top of the micro flame 4.

### Experimental Example 5

The measurement of an electromotive force was performed, just as with the experimental example 1, by the use of the thermoelectric generator 1b having the outline of its main construction shown in FIG. 4B. The measurement result is shown as a temporal change in the electromotive force in FIG. 7C. Here, in this experimental example, the heating part of the thermoelectric element 2 was located about 9 mm above the top of the micro flame 4. Moreover, the main constituent members of the thermoelectric generator 1b were the same as those of the thermoelectric generator 1 of the experimental example 1. It was found that the thermoelectric generator 1b could keep an electromotive force of about 1.4 V for two hours or more.

Moreover, in this experimental example, the thermoelectric generator 1 was modified to produce eight micro flames 4. Then, when the eight micro flames 4 heated the thermoelectric element 2 at the same time, the thermoelectric generator could stably keep an electromotive force of about 11 V for about two hours. In this modified thermoelectric generator, the heat source unit 3 is composed of a plurality of micro flames 4.

1. A thermoelectric generator having a thermoelectric element that has a cooling part and a heating part and generates electric power by utilizing a temperature difference between the cooling part and the heating part, wherein
a heat source for heating the heating part is a micro flame.

2. The thermoelectric generator according to claim 1, wherein
the heating source includes a plurality of micro flames.

3. The thermoelectric generator according to claim 1, wherein
the micro flame can be produced by burning liquid fuel that is liquid at room temperature and normal pressure.

4. The thermoelectric generator according to claim 3, wherein
the liquid fuel is ethanol or a mixture of ethanol and a solvent.

5. The thermoelectric generator according to claim 3, comprising a container for containing the liquid fuel, a cylindrical body that is connected with an interior of the container and projects from the container, and a capillary tube that passes through the cylindrical body from the container and projects outside from the container, wherein
the micro flame is produced at an top end of the cylindrical body by the liquid fuel transported to the top end of the capillary tube by means of a capillary phenomenon.

6. The thermoelectric generator according to any one of claims 1, wherein
all or part of the heating part is opposed to a side portion of the micro flame.

7. The thermoelectric generator according to claim 2, wherein
the plurality of micro flames can be produced by burning liquid fuel that is liquid at room temperature and normal pressure.

8. The thermoelectric generator according to claim 4, comprising a container for containing the liquid fuel, a cylindrical body that is connected with an interior of the container and projects from the container, and a capillary tube that passes through the cylindrical body from the container and projects outside from the container, wherein
the micro flame is produced at an top end of the cylindrical body by the liquid fuel transported to the top end of the capillary tube by means of a capillary phenomenon.

9. The thermoelectric generator according to claim 7, comprising a container for containing the liquid fuel, a cylindrical body that is connected with an interior of the container and projects from the container, and a capillary tube that passes through the cylindrical body from the container and projects outside from the container, wherein
the plurality of micro flames is produced at an top end of the cylindrical body by the liquid fuel transported to the top end of the capillary tube by means of a capillary phenomenon.
